(19) United States
(12) Patent Application Publication
(10) Pub. No.: US 2021/0242931 A1
(43) Pub. Date: Aug. 5, 2021

(54) ENVIRONMENTAL DETECTION SYSTEMS AND METHODS FOR HIGH ALTITUDE PLATFORMS

(71) Applicant: Loon LLC, Mountain View, CA (US)

(72) Inventors: Thomas Swanson, Mountain View, CA (US); Matthew Stokes, San Francisco, CA (US)

(21) Appl. No.: 16/778,223

(22) Filed: Jan. 31, 2020

(51) Int. Cl. H04B 7/185; G01W 1/08; B64C 39/02; B64B 1/50; G01W 1/16; G01W 1/02

(52) U.S. Cl. CPC H04B 7/18504; G01W 1/08; B64C 39/02; B64B 1/50; B64C 2201/125; G01W 1/02; B64C 2201/022; B64C 2201/122; G01W 1/16

(57) ABSTRACT

Aspects of the technology relate to an environmental sensor system that uses different types of detector units as part of an onboard lightning detection and evaluation system for a high altitude platform (HAP) operating in the stratosphere. These sensor suites may be employed with balloons and other high altitude platforms during operation in the stratosphere. Onboard data processing and analysis may be done either in real time or on stored data sets. The processing system can use the gathered sensor information to mitigate issues related to lightning-related transients. The information can also be used in route planning and real-time navigation of HAPs when hazardous conditions are detected. It can also be employed in a back-end control system for long-term route planning and fleet management.

### BACKGROUND

Telecommunications connectivity via the Internet, cellular data networks and other systems is available in many parts of the world. However, there are many locations where such connectivity is unavailable, unreliable or subject to outages from natural disasters. Some systems may provide network access to remote locations or to locations with limited networking infrastructure via satellites or high altitude platforms located in the stratosphere. In the latter case, due to environmental conditions and other limitations, it is challenging to keep the platforms aloft and operational over a desired service area for long durations, such as days, weeks or more. For instance, while stratospheric operation means that a high altitude platform is generally above most cloud formations and storms, lightning-induced transients can cause system failures and other operational issues. This can adversely impact the ability of the platform to provide communication connectivity.

### SUMMARY

Aspects of the technology include sensor suites that gather environmental information, which can be used in an onboard lightning detection and evaluation system. These sensor suites may be employed with balloons and other high altitude platforms (HAPs) designed to operate in the stratosphere (e.g., at or above 50,000-70,000 feet) during long life missions (e.g., in excess of 100 days aloft). Data processing can be performed at the HAP, either in real time on received data or post processing of stored data sets. The information from the sensor suites can be used to identify and mitigate issues related to lightning-related transients. It can also be employed in route planning and real-time navigation of HAPs when hazardous conditions are detected.

In the past, significant research has been conducted regarding lightning and its impact at lower altitudes, such as altitudes at which commercial aircraft travel. However, the stratospheric environment is significantly different than the environment at low to medium altitudes. The impact of lightning transients on stratospheric HAPs may also be quite different than the impact on commercial aircraft and other airborne objects operating below the stratosphere. Thus, specialized sensor suites have been designed to address the different environmental and platform considerations.

According to one aspect, an environmental sensor system for a high altitude platform configured for operation in the stratosphere is provided. The environmental sensor system includes a plurality of different detector modules configured to detect environmental factors associated with lightning occurring below the high altitude platform when operating in the stratosphere. The plurality of different detector modules includes at least a lightning detector, a transient pulse detector and an electric field detector. The plurality of different detector modules is arranged in one or more sensor suites configured for placement on the high altitude platform. The environmental sensor system also includes memory configured to store data received from the plurality of different detector modules. The data is associated with the detected environmental factors. The environmental sensor system further includes one or more processors operatively coupled to the memory and the plurality of different detector modules. The one or more processors are configured to receive the data from the plurality of different detector modules, and to control at least one of a vertical or lateral position of the high altitude platform based on a likelihood of lightning in the environment below the high altitude platform when operating in the stratosphere.

In one example, the one or more processors are further configured to transmit the stored data to a remote station for analysis, and receive a command from the remote station to control at least one of the vertical or lateral position based on the likelihood of lightening in the environment below the high altitude platform. The plurality of different detector modules may include a magnetic field detector. The plurality of different detector modules may include a corona current detector. The corona current detector may include a discharge wire extending from the high altitude platform when operating in the stratosphere. The system may further comprise one or more additional detector modules selected from a group of a humidity detector, a temperature detector or an optical detector. The one or more processors may also be configured to transmit the stored data to another high altitude platform.

The system may further include a heater module configured to heat one or more of the plurality of different detector modules above a threshold temperature. In this example, the heater module may include a main heater element and an auxiliary heater element. The auxiliary heater element can be configured to increase a temperature of a moisture detector of the plurality of different detector modules.

According to another aspect, a high altitude platform is configured for operation in the stratosphere and includes an environmental sensor system as described above, an envelope having a lighter-than-air gas therein, and a payload coupled to the envelope. The one or more sensor suites may include first and second sensor suites, in which the first sensor suite is disposed along a portion of the payload, and the second sensor suite is disposed along a portion of the envelope. For instance, the first sensor suite may include a corona current detector having a wire extending downward from the payload, and the second sensor suite may be disposed adjacent to a base portion of the envelope.

According to a further aspect, a method for managing high altitude platform operation in the stratosphere is provided. The method comprises receiving, by one or more processors, sensor data from a plurality of different detector modules of a high altitude platform, the sensor data including environmental factors associated with lightning occurring below the high altitude platform when operating in the stratosphere; processing, by the one or more processors, the sensor data from the plurality of different detector modules to identify a likelihood of lightning in the environment below the high altitude platform; and the one more processors generating a command, based on the processing, to control at least one of a vertical or lateral position of the high altitude platform based on the identified likelihood of lightening in the environment below the high altitude platform. In one example, the method further comprises transmitting the command to the high altitude platform.

In one scenario, the plurality of different detector modules includes at least a lightning detector, a transient pulse detector and an electric field detector. Here, the processing includes correlating the received sensor data from the lightning detector, the transient pulse detector and the electric field detector to determine whether the likelihood of lightening in the environment below the high altitude platform exceeds a threshold likelihood.

The processing may include correlating the received sensor data against historical weather data. Here, the historical weather data may include at least one of satellite cloud-top-height imagery, convective analysis reports, or satellite lightning-mapping imagery.

The processing may include aggregating sensor data received from a fleet of high altitude platforms and evaluating performance of a storm-avoidance procedure employed for the fleet. The processing may alternatively or additionally include performing a failure analysis to determine whether a failure is due to a storm condition. The processing may alternatively or additionally include performing a failure analysis to classify a failure based on a magnitude of a detected electrical event. And the processing may alternatively or additionally include issuing a command to vary one or more parameters of at least one of the plurality of different detector modules.

### BRIEF DESCRIPTION OF THE DRAWINGS

FIG. 1 is a functional diagram of an example system in accordance with aspects of the technology.

FIG. 2 illustrates a balloon configuration in accordance with aspects of the technology.

FIG. 3 is an example payload arrangement in accordance with aspects of the technology.

FIG. 4 is an example of a balloon platform with lateral propulsion in accordance with aspects of the technology.

FIG. 5 illustrates an example environmental sensor system in accordance with aspects of the technology.

FIG. 6 illustrates an example transient pulse detector in accordance with aspects of the technology.

FIG. 7 illustrates an example electric field detector in accordance with aspects of the technology.

FIG. 8 illustrates an example electric field detector in accordance with aspects of the technology.

FIG. 9 illustrates an example of a corona current detector in accordance with aspects of the technology.

FIG. 10 illustrates an example moisture detector in accordance with aspects of the technology.

FIG. 11 illustrates an example lighter-than-air high altitude platform in accordance with aspects of the technology.

FIG. 12 illustrates an example remote system in accordance with aspects of the technology.

FIG. 13 illustrates a method in accordance with aspects of the technology.

### DETAILED DESCRIPTION

### Overview

The technology relates to an environmental sensor system for HAPs operating in the stratosphere. Information associated with lightning-induced transients is gathered and processed by the HAP. This information can be used by the onboard navigation system for storm avoidance, and can be employed in a back-end control system for long-term route planning and fleet management.

Stratospheric high altitude balloon platforms may have a float altitude of between about 50,000-120,000 feet above sea level. At such heights, the density of the air is very low compared to ground level. For example, while the pressure at ground level is around 1,000 mbar, the pressure in the lower stratosphere may be on the order of 100 mbar and the pressure in the upper stratosphere may be on the order of 1 mbar. The temperature in the stratosphere generally increases with altitude. For instance, in the lower stratosphere the average temperature may be on the order of −40° C. to −100° C. or colder, while the average temperature in the upper stratosphere may be on the order of −15° C. to −5° C. or warmer. In addition, while balloons and other HAPs in the stratosphere generally fly above the clouds and most weather conditions, the HAPs can be impacted by lightning-induced transients beneath them. Such transients can cause component or system-wide failures, which can reduce or cut short the HAP's operational lifetime. The systems and processes discussed below are configured to detect these transients and enable effective operation in response.

### Example Balloon Systems

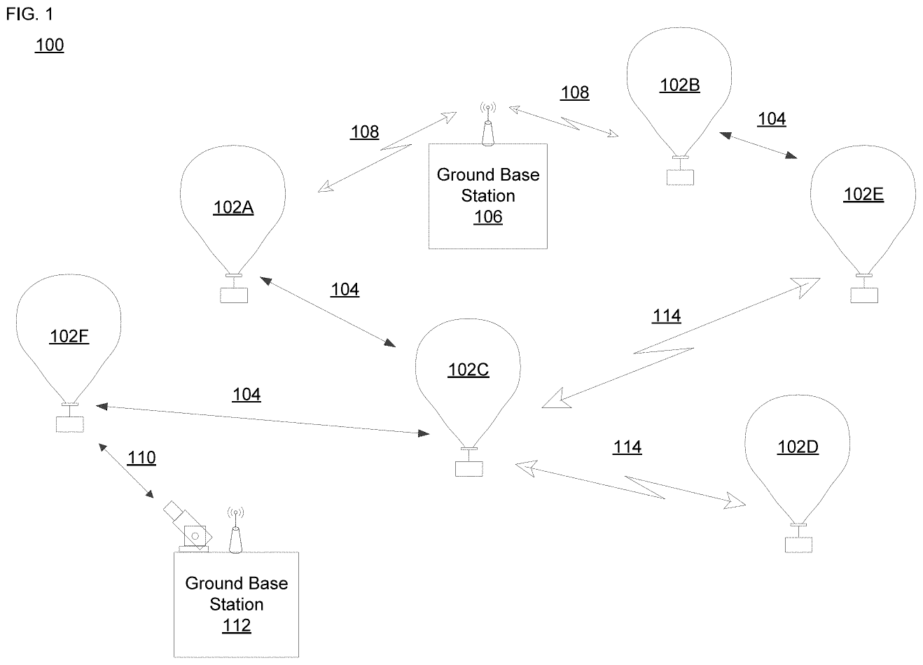

FIG. 1 depicts an example system 100 in which a fleet of balloons, airships or other high altitude platforms described above may be used. This example should not be considered as limiting the scope of the disclosure or usefulness of the features described herein. System 100 may be considered a balloon network. In this example, balloon network 100 includes a plurality of devices, such as balloons or other lighter-than-air craft 102A-F as well as ground base stations 106 and 112. Balloon network 100 may also include a plurality of additional devices, such as various computing devices (not shown) as discussed in more detail below or other systems that may participate in the network.

The devices in system 100 are configured to communicate with one another. As an example, the balloons may include communication links 104 and/or 114 in order to facilitate intra-balloon communications. By way of example, links 114 may employ radio frequency (RF) signals (e.g., millimeter wave transmissions) while links 104 employ free-space optical transmission. Alternatively, all links may be RF, optical, or a hybrid that employs both RF and optical transmission. In this way balloons 102A-F may collectively function as a mesh network for data communications. At least some of the balloons may be configured for communications with ground-based stations 106 and 112 via respective links 108 and 110, which may be RF and/or optical links.

In one scenario, a given balloon 102 may be configured to transmit an optical signal via an optical link 104. Here, the given balloon 102 may use one or more high-power light-emitting diodes (LEDs) to transmit an optical signal. Alternatively, some or all of the balloons 102 may include laser systems for free-space optical communications over the optical links 104. Other types of free-space communication are possible. Further, in order to receive an optical signal from another balloon via an optical link 104, the balloon may include one or more optical receivers.

The balloons may also utilize one or more of various RF air-interface protocols for communication with ground-based stations via respective communication links. For instance, some or all of balloons 102A-F may be configured to communicate with ground-based stations 106 and 112 via RF links 108 using various protocols described in IEEE 802.11 (including any of the IEEE 802.11 revisions), cellular protocols such as GSM, CDMA, UMTS, EV-DO, WiMAX, and/or LTE, 5G and/or one or more proprietary protocols developed for long distance communication, among other possibilities.

In some examples, the links may not provide a desired link capacity for balloon-to-ground communications. For instance, increased capacity may be desirable to provide backhaul links from a ground-based gateway. Accordingly, an example network may also include downlink balloons, which could provide a high-capacity air-ground link between the various balloons of the network and the ground base stations. For example, in balloon network 100, balloon 102F may be configured as a downlink balloon that directly communicates with station 112.

Like other balloons in network 100, downlink balloon 102F may be operable for communication (e.g., RF or optical) with one or more other balloons via link(s) 104. Downlink balloon 102F may also be configured for free-space optical communication with ground-based station 112 via an optical link 110. Optical link 110 may therefore serve as a high-capacity link (as compared to an RF link 108) between the balloon network 100 and the ground-based station 112. Downlink balloon 102F may additionally be operable for RF communication with ground-based stations 106. In other cases, downlink balloon 102F may only use an optical link for balloon-to-ground communications. Further, while the arrangement shown in FIG. 1 includes just one downlink balloon 102F, an example balloon network can also include multiple downlink balloons. On the other hand, a balloon network can also be implemented without any downlink balloons.

A downlink balloon may be equipped with a specialized, high bandwidth RF communication system for balloon-to-ground communications, instead of, or in addition to, a free-space optical communication system. The high bandwidth RF communication system may take the form of an ultra-wideband system, which may provide an RF link with substantially the same capacity as one of the optical links 104.

In a further example, some or all of balloons 102A-F could be configured to establish a communication link with space-based satellites and/or other types of HAPs (e.g., drones, airplanes, airships, etc.) in addition to, or as an alternative to, a ground based communication link. In some embodiments, a balloon may communicate with a satellite or a high altitude platform via an optical or RF link. However, other types of communication arrangements are possible.

As noted above, the balloons 102A-F may collectively function as a mesh network. More specifically, since balloons 102A-F may communicate with one another using free-space optical links or RF links, the balloons may collectively function as a free-space optical or RF mesh network. In a mesh-network configuration, each balloon may function as a node of the mesh network, which is operable to receive data directed to it and to route data to other balloons. As such, data may be routed from a source balloon to a destination balloon by determining an appropriate sequence of links between the source balloon and the destination balloon.

The network topology may change as the balloons move relative to one another and/or relative to the ground. Accordingly, the balloon network 100 may apply a mesh protocol to update the state of the network as the topology of the network changes. For example, to address the mobility of the balloons 102A to 102F, the balloon network 100 may employ and/or adapt various techniques that are employed in mobile ad hoc networks (MANETs). Other examples are possible as well.

Balloon network 100 may also implement station-keeping functions using winds and altitude control or lateral propulsion to help provide a desired network topology. For example, station-keeping may involve some or all of balloons 102A-F maintaining and/or moving into a certain position relative to one or more other balloons in the network (and possibly in a certain position relative to a ground-based station or service area). As part of this process, each balloon may implement station-keeping functions to determine its desired positioning within the desired topology, and if necessary, to determine how to move to and/or maintain the desired position.

The desired topology may vary depending upon the particular implementation and whether or not the balloons are continuously moving. In some cases, balloons may implement station-keeping to provide a substantially uniform topology where the balloons function to position themselves at substantially the same distance (or within a certain range of distances) from adjacent balloons in the balloon network 100. Alternatively, the balloon network 100 may have a non-uniform topology where balloons are distributed more or less densely in certain areas, for various reasons. As an example, to help meet the higher bandwidth demands, balloons may be clustered more densely over areas with greater demand (such as urban areas) and less densely over areas with lesser demand (such as over large bodies of water). In addition, the topology of an example balloon network may be adaptable allowing balloons to adjust their respective positioning in accordance with a change in the desired topology of the network.

The balloons of FIG. 1 may be high-altitude balloons that are deployed in the stratosphere. As an example, in a high altitude balloon network, the balloons may generally be configured to operate at stratospheric altitudes, e.g., between 50,000 ft and 70,000 ft or more or less, in order to limit the balloons' exposure to high winds and interference with commercial airplane flights. In order for the balloons to provide a reliable mesh network in the stratosphere, where winds may affect the locations of the various balloons in an asymmetrical manner, the balloons may be configured to move latitudinally and/or longitudinally relative to one another by adjusting their respective altitudes, such that the wind carries the respective balloons to the respectively desired locations. And as discussed below, lateral propulsion may also be employed to affect the balloon's path of travel.

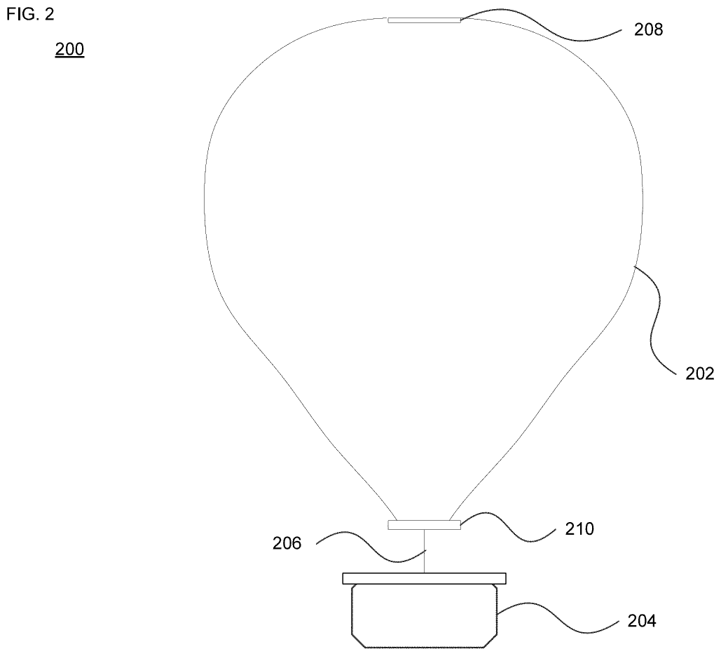

In an example configuration, the high altitude balloon platforms include an envelope and a payload, along with various other components. FIG. 2 is one example of a high-altitude balloon 200, which may represent any of the balloons of FIG. 1. As shown, the example balloon 200 includes an envelope 202, a payload 204 and a coupling member (e.g., a down connect) 206 therebetween. At least one gore panel forms the envelope, which is configured to maintain pressurized lifting gas therein. For instance, the balloon may be a superpressure balloon. A top plate 208 may be disposed along an upper section of the envelope, while a base plate 210 may be disposed along a lower section of the envelope opposite the top place. In this example, the coupling member 206 connects the payload 204 with the base plate 210.

The envelope 202 may take various shapes and forms. For instance, the envelope 202 may be made of materials such as polyethylene, mylar, FEP, rubber, latex or other thin film materials or composite laminates of those materials with fiber reinforcements imbedded inside or outside. Other materials or combinations thereof or laminations may also be employed to deliver required strength, gas barrier, RF and thermal properties. Furthermore, the shape and size of the envelope 202 may vary depending upon the particular implementation. Additionally, the envelope 202 may be filled with different types of gases, such as air, helium and/or hydrogen. Other types of gases, and combinations thereof, are possible as well. Shapes may include typical balloon shapes like spheres and “pumpkins”, or aerodynamic shapes that are symmetric, provide shaped lift, or are changeable in shape. Lift may come from lift gasses (e.g., helium, hydrogen), electrostatic charging of conductive surfaces, aerodynamic lift (wing shapes), air moving devices (propellers, flapping wings, electrostatic propulsion, etc.) or any hybrid combination of lifting techniques.

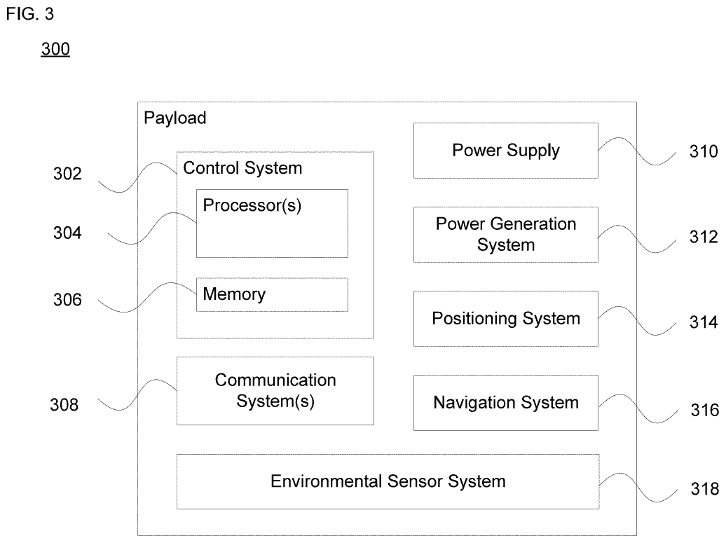

According to one example shown in FIG. 3, a payload 300 of a balloon platform includes a control system 302 having one or more processors 304 and on-board data storage in the form of memory 306. Memory 306 stores information accessible by the processor(s) 304, including instructions that can be executed by the processors. The memory 306 also includes data that can be retrieved, manipulated or stored by the processor. The memory can be of any non-transitory type capable of storing information accessible by the processor, such as a hard-drive, memory card (e.g., thumb drive or SD card), ROM, RAM, and other types of write-capable, and read-only memories. The instructions can be any set of instructions to be executed directly, such as machine code, or indirectly, such as scripts, by the processor. In that regard, the terms “instructions,” “application,” “steps” and “programs” can be used interchangeably herein. The instructions can be stored in object code format for direct processing by the processor, or in any other computing device language including scripts or collections of independent source code modules that are interpreted on demand or compiled in advance. The data can be retrieved, stored or modified by the one or more processors 304 in accordance with the instructions.

The one or more processors 304 can include any conventional processors, such as a commercially available CPU. Alternatively, each processor can be a dedicated component such as an ASIC, controller, or other hardware-based processor. Although FIG. 3 functionally illustrates the processor(s) 304, memory 306, and other elements of control system 302 as being within the same block, the system can actually comprise multiple processors, computers, computing devices, and/or memories that may or may not be stored within the same physical housing. For example, the memory can be a hard drive or other storage media located in a housing different from that of control system 302. Accordingly, references to a processor, computer, computing device, or memory will be understood to include references to a collection of processors, computers, computing devices, or memories that may or may not operate in parallel.

The payload 300 may also include various other types of equipment and systems to provide a number of different functions. For example, as shown the payload 300 includes one or more communication systems 308, which may transmit signals via RF and/or optical links as discussed above. The communication system(s) 308 include communication components such as one or more transmitters and receivers (or transceivers), one or more antennae, and a baseband processing subsystem. (not shown)

The payload 300 is illustrated as also including a power supply 310 to supply power to the various components of balloon. The power supply 310 could include one or more rechargeable batteries or other energy storage systems like capacitors or regenerative fuel cells. In addition, the balloon 300 may include a power generation system 312 in addition to or as part of the power supply. The power generation system 312 may include solar panels, stored energy (hot air), relative wind power generation, or differential atmospheric charging (not shown), or any combination thereof, and could be used to generate power that charges and/or is distributed by the power supply 310.

The payload 300 may additionally include a positioning system 314. The positioning system 314 could include, for example, a global positioning system (GPS), an inertial navigation system, and/or a star-tracking system. The positioning system 314 may additionally or alternatively include various motion sensors (e.g., accelerometers, magnetometers, gyroscopes, and/or compasses). The positioning system 314 may additionally or alternatively include one or more video and/or still cameras, and/or various sensors for capturing environmental data. Some or all of the components and systems within payload 300 may be implemented in a radiosonde or other probe, which may be operable to measure, e.g., pressure, altitude, geographical position (latitude and longitude), temperature, relative humidity, and/or wind speed and/or wind direction, among other information. Wind sensors may include different types of components like pitot tubes, hot wire or ultrasonic anemometers or similar, windmill or other aerodynamic pressure sensors, laser/lidar, or other methods of measuring relative velocities or distant winds.

Payload 300 may include a navigation system 316 separate from, or partially or fully incorporated into control system 302. The navigation system 316 may implement station-keeping functions to maintain position within and/or move to a position in accordance with a desired topology or other service requirement. In particular, the navigation system 316 may use wind data (e.g., from onboard and/or remote sensors) to determine altitudinal and/or lateral positional adjustments that result in the wind carrying the balloon in a desired direction and/or to a desired location. Lateral positional adjustments may also be handled directly by a lateral positioning system that is separate from the payload. Alternatively, the altitudinal and/or lateral adjustments may be computed by a central control location and transmitted by a ground based, air based, or satellite based system and communicated to the high-altitude balloon. In other embodiments, specific balloons may be configured to compute altitudinal and/or lateral adjustments for other balloons and transmit the adjustment commands to those other balloons.

An environmental sensor system 318 is also shown, which may encompass some or all of the probes and other sensors mentioned above. In addition, the environmental sensor system 318 includes other sensors configured to detect information associated with lightning, which are discussed further below. The lightning information detected by the sensors of the system 318 may be used by the navigation system 316 to adjust the current or planned course of the HAP. It may also be transmitted to a remote base station, control center, etc., for instance to aid in future weather prediction and overall HAP fleet planning. Such remote systems can process and compare the received information against wind models, weather prediction models and/or data received from a third party weather service. Based on this, a remote systems can provide flight plan or other navigation instructions to a given HAP, and can make fleet-wide corrections to avoid potential issues due to lightning transients while providing a threshold amount of communication coverage (or other service) over a region of interest.

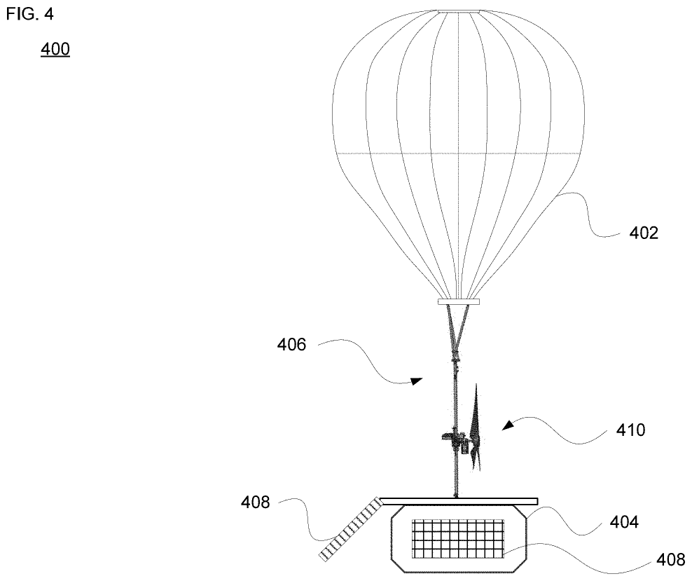

In order to effect lateral positions or velocities, the platform may include a lateral propulsion system. FIG. 4 illustrates one example configuration 400 of a balloon platform with propeller-based lateral propulsion, which may represent any of the balloons of FIG. 1. As shown, the example 400 includes an envelope 402, a payload 404 and a down connect member 406 disposed between the envelope 402 and the payload 404. Cables or other wiring between the payload 404 and the envelope 402 may be run within the down connect member 406. One or more solar panel assemblies 408 may be coupled to the payload 404 or another part of the balloon platform. The payload 404 and the solar panel assemblies 408 may be configured to rotate about the down connect member 406 (e.g., up to 360° rotation), for instance to align the solar panel assemblies 408 with the sun to maximize power generation. Example 400 also illustrates a lateral propulsion system 410. While this example of the lateral propulsion system 410 is one possibility, the location could also be fore and/or aft of the payload section 404, or fore and/or aft of the envelope section 402, or any other location that provides the desired thrust vector.

The navigation system is able to evaluate data obtained from onboard navigation sensors, such as an altimeter, inertial measurement unit (IMU) and/or differential GPS, received data (e.g., weather information), and/or other sensors such as health and performance sensors (e.g., a force torque sensor) to manage operation of the balloon's systems. When decisions are made to activate the lateral propulsion system, the navigation system then leverages received sensor data for position, wind direction, altitude and power availability to properly point the propeller and to provide a specific thrust condition for a specific duration or until a specific condition is reached (e.g., a specific velocity or position is reached, while monitoring and reporting overall system health, temperature, vibration, and other performance parameters). In this way, the navigation system can continually optimize the use of the lateral propulsion systems for performance, safety and system health.

By way of example, a lateral propulsion controller of the lateral propulsion system may be configured to continuously control the propeller's pointing direction, manage speed of rotation, power levels, and determine when to turn on the propeller or off, and for how long. The lateral propulsion controller thus oversees the thruster pointing direction, thruster power level and thruster on-time operation. The lateral propulsion controller may be separate from or part of the processor(s) of the payload. Processor software or received human controller decisions may set priority on what power is available for lateral propulsion functions. The navigation system then decides how much of that power to apply to the lateral propulsion motors and when to apply it in order to achieve a navigation goal.

### Example Configurations

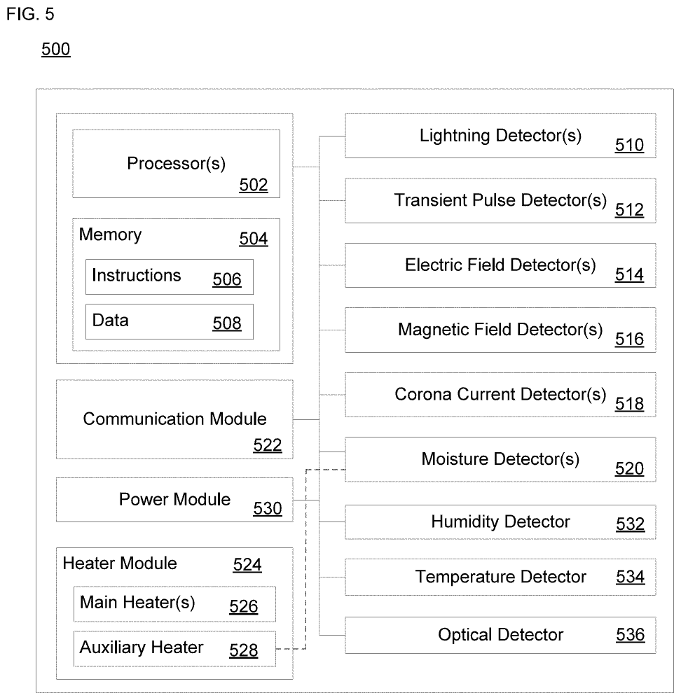

FIG. 5 illustrates an example 500 of the environmental sensor system 318 of FIG. 3. As shown, example 500 includes a processing module with one or more processors 502 and memory 504, which may be the same or separate from the processors 304 and memory 306 of FIG. 3. By way of example, the processor(s) 502 may be a microcontroller, ASIC or other type of processor as described above. And the memory may include any of the types discussed above with regard to memory 306, including an SD card or other type of removable storage. The memory 504 includes instructions 506 and data 508. By way of example, the data may include raw and processed data obtained by the detectors of the environmental sensor system. The instructions may include, e.g., a program for a storm avoidance procedure based on the received data. In one scenario, sensor data from some subset of the fleet or the entire fleet can be aggregated and used to evaluate the performance of the storm-avoidance procedures. For instance, if a given storm avoidance approach is working as expected, detection of storm activity may be expected to fall below a selected threshold. However, if the sensors frequently detect storm activity, that may be an indicator that an adjustment should be made to the that particular approach. In addition, detected sensor data may be compared against weather data received from other sources (e.g., third party weather services) and use it as a way to validate the received data. In particular, the sensors provide a ground truth that allows the system to explore missing or incorrect data. The sensors can also provide a real-time warning of risk due to storms. Thus, if a particular platform detects substantial electrical activity, a flight engineer or planning system can be notified so that corrective action can be taken (e.g., ascend the platform). The sensor data can also be a powerful tool for failure analysis of in-flight issues. By way of example, for some failures it is possible to rule out storms as a root cause based on the sensor data. For other failures, the system may be able to classify failures based on the magnitude of electrical events. This can help target design improvements and make the entire system more robust.

As shown in FIG. 5, the environmental sensor system may include one or more of a lightning detector 510, transient pulse detector 512, electric field detector 514, magnetic field detector 516, corona current detector 518, and a moisture detector 520. One or more of each type of detector may be found in a given environmental sensor system suite. A given HAP may have one, two or more such suites arranged in various locations of the HAP's structure. Each suite may have the same or different sets of detector subsystems. An analog-to-digital (ADC) converter (not shown) may convert analog signals from the detectors to digital signals prior to the processor(s) receiving the signals.

A communication module 522 is able to provide local communication (e.g., data retrieval) between the detectors and the processor(s). The communication module 522 may include, for instance, a Controller Area Network (CAN)-type bus and/or an Ethernet-type bus. For instance, a CAN bus may be used to communicate between major subsystems while an Ethernet bus may be used for local processor-to-processor communication. The communication module 522 may alternatively or additionally interface with the communication system(s) 308 of the payload, for instance via a wireless or wired connection. One factor in selecting the communication protocols and/or communication architectures is the bandwidth needed for transferring data. In a long duration lighter-than-air platform, the onboard communication module may be relatively bandwidth constrained due to numerous processors sharing the system. The information obtained by the onboard detectors and other sensors may need to be reduced in terms of data size and/or data rate (e.g., on the order of 1 byte per minute, or more or less).

As shown, a heater module 524 includes one or more heater units. This includes one or more main heaters 526, and optionally an auxiliary heater 528. Ambient temperatures may typically be in the range of −70° C. to −100° C. In the daytime, the temperature may be higher due to radiative heating from the sun. Even so, during daytime operation the system may need the main heater 526 to keep the temperature of the detectors, other components and/or circuit boards of the environmental sensor system within a selected operating range. For instance, should a threshold temperature fall below, e.g., −30° C. to −40° C., the heater(s) 526 may be activated. Similarly, at night or in other conditions where the temperature drops below the threshold, the heater(s) 526 would be activated. As indicated by the dashed line, the auxiliary heater 528 may be used to control the temperature of the moisture detector 520, for instance to melt any ice should there be an accumulation on the moisture detector. In one example, each heater unit may include a set of resistive elements arranged in parallel, and which may be enabled by application of current to the heater unit.

Power module 530 is configured to supply and regulate power to the different subsystems of the environmental sensor system. This can include individual supplies for the specific voltages required by each sensor unit (e.g., 5V or 3V), which can be switched on and off as needed. The power module 530 may receive its power from the power generation system 312 and/or power supply 310.

Finally, in addition to the sensor units mentioned above, the environmental sensor system may also include a humidity detector 532, a temperature detector 534 and/or an ambient optical detector 536 to detect visual indicia of lightning. The different detector modules are described further below.

### Detector Modules

The lightning detector 510 is configured to provide long range detection of lightning activity. For instance, this unit may detect cloud to cloud or cloud to ground activity up to 30-40 km from the HAP. In one example, the lightning detector may be an integrated circuit component, such as an off-the-shelf AS3935 IC from AMS AG. The processors 502 or a separate counter unit may increment a counter every time the lightning detector detects a lightning strike. The counter provides a rough warning that lightning is nearby the HAP, although it may not provide a reliable estimate of the strength of the transients or the induced effects on the HAP. The information output from the lightning detector can be used to evaluate whether background noise is too high to capture a strike event, whether a strike has been captured but does not meet the classification as lightning (a “disturber” count), and a lightning strike count, where the strike has been captured and does meet the lightning classification. One or more parameters of the lightning detector may be adjustable by the onboard system or a remote system. This can include the spike rejection threshold, which can be used to adjust the classification of lightning from a detected strike. According to one aspect, data from the lightning detector may be captured with a sample period on the order of 1 Hz. Additionally, information from the counter may be maintained even if the module is rebooted.

The transient pulse detector 512 may be used to provide additional information to supplement the data received from the lightning detector. For instance, this detector may be a less sensitive circuit than the lightning detector and which employs a fixed detection threshold. This sensor may not differentiate between lightning and other noise sources (e.g., on-board systems of the payload, such as communication or transponder units). The transient pulse detector is able to provide a rough warning that lightning is in the area, but may not provide sufficient information about the strength of the induced fields or transients. Similar to the lightning detector, the transient pulse detector is associated with a counter that increments every time a transient is detected. Evaluating the information gathered by the lightning detector and the transient pulse detector, the processor may be able to determine that there is a likelihood of lightning within a threshold distance of the HAP (e.g., within 15-40 km).

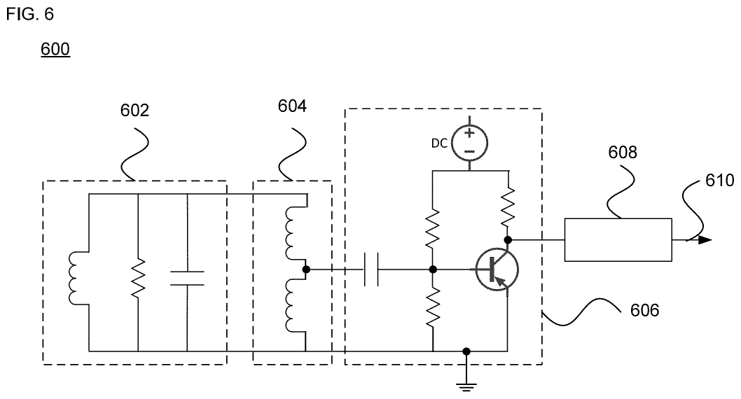

FIG. 6 illustrates one example 600 of the transient pulse detector 512. As shown, the transient pulse detector in this example includes an antenna and resonant tank circuit 602, an impedance match and filter circuit 604, an amplifier circuit 606, and a pulse stretching IC 608. For instance, the antenna and resonant tank circuit 602 operates at about 300 kHz (+/−20%), which is a suitable frequency for receiving energy from lightning. The two series inductors of the impedance match and filter circuit 604 act as a matching network, feeding the transistor of the amplifier circuit 606 with a lower impedance version of the signal received by the antenna. The resistor tied to ground in the amplifier circuit is selected to lower the Q of the resonant tank to prevent oscillation.

The inductors of the impedance and match filter circuit 604 present a low-impedance source for the amplifier. A capacitor may be added in parallel with the lower inductor to filter out high frequency noise from other devices of the HAP. The amplifier circuit 606 is configured to amplify the 300 kHz bursts and apply the amplified signal to the pulse stretching circuit 608. By way of example, the pulse stretching circuit may include an IC with a monostable multivibrator with Schmitt-trigger inputs. The circuit 608 is used to filter down to a single pulse per transient event. It is also able to lengthen the pulse to make it detectable by the processor(s). Signal 610 is output from the circuit 608. The circuit 608 may be configured so that the signal 610 has a pulse on the order of 5-20 microseconds for every transient event that is detected. The monostable multivibrator is re-triggerable, so the output will simply stay asserted if multiple pulses are received in rapid succession.

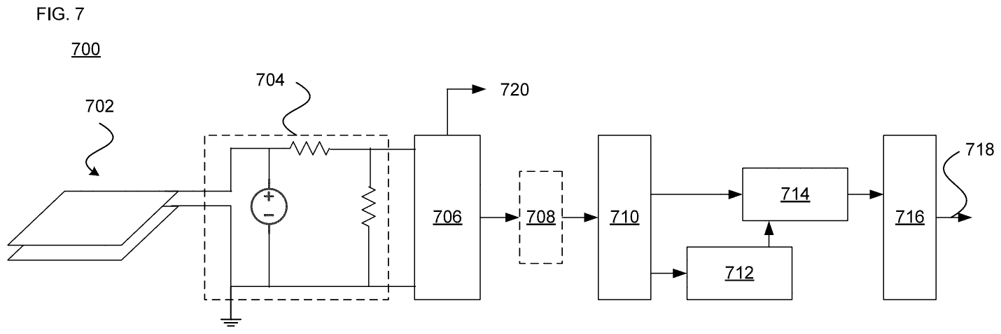

FIG. 7 illustrates one example 700 of the electric field detector 514. Induced transients are caused by rapidly-changing electric fields. To set test levels and the size of protection appropriately for the HAP, it is important to understand the magnitude of these fields. In this example, the electric field detector employs two parallel plates 702. When the ambient electric field changes rapidly (a large dE/dt), it sets up a displacement current between the parallel plates that are measured with a current sense resistor. For instance, the electric field detector may be configured to handle rates of change in the ambient electric field of up to 10¹² Volts per meter per second (V/m/s). Changes in the electric field of this magnitude would only happen in or around a lightning strike The peak of this waveform is then captured by the detector. The output is a voltage. In one embodiment, the peaks of the waveform are held for a very short period of time (e.g., 1-2 microseconds), and are continuously accessible to the processor 502.

For instance, as shown the displacement current from the plates 702 is applied to a current sense resistor and voltage divider unit 704. While it is not necessary to perform voltage division at the current sensing stage, it may help reduce the amount of division performed by the next stage at voltage divider module 706. In one scenario, the voltage divider module 706 is a /1 or /10 voltage divider. It may output an electric field range signal in addition to the divided signal. The divided signal may be filtered at block 708 before being amplified by amplifier 710. The amplified signal is provided to an inverter 712 and a peak detector 714, with the signal from the inverter also being fed to the peak detector. In one embodiment, the peak detector 714 acts as a low pass filter with a cutoff frequency on the order of, e.g., 14-18 MHz.

The output signal from the peak detector 714 is input to buffer 716. The buffer 716 also acts as a low pass filter with a cutoff frequency on the order of, e.g., 14-18 MHz. The output signal 718 is a voltage, which may be between, e.g., 0V to 2.5V or more. A signal 720 may also be output by the voltage divider module 706, which can be used to enable or disable an opto-isolator to switch between the 1× and 10× divider ratios.

The output signal 718 can be post-processed as follows. In one example, the data is sampled at a rate on the order of 0.5-2.0 MHz over a rolling 30-minute window. This can vastly reduce the amount of data to be processed by the processor while providing an accurate peak value over the rolling window. Additionally, using this sampled maximum value data as the input source, an above threshold count with a configurable threshold may be provided. The threshold may be configured by the onboard processing system or by a remote ground station. Peak detection and statistics filtering may be performed as follows. Raw analog to digital converter (ADC) counts for the input pin are sampled (e.g., via a timer configured with a trigger period of 1 MHz) using doubled-buffered direct memory access (DMA) and stored into a first one of the buffers. Once the first buffer has been filled, the information in that buffer is then processed to find the maximum value. This maximum value is inserted into the second buffer. Downsampling will vary depending on the sizing of the first buffer, in which a larger will result in less frequent processing, but come at the cost of increased storage. The first buffer is then returned to the free buffer pool. While the data from the first buffer is being processed, ADC data is being captured into a separate buffer ensuring that no samples are missed during processing. A separate process, which may run on the order of 1 Hz, processes entries in the second buffer of the double-buffered DMA (a shared queue) to find the maximum value, outputting processed entries. This maximum value is then converted from raw ADC counts to a voltage (e.g., using a provided positive and negative reference voltage) and reported. Reported values can be made available to other subsystems (accessible over a CAN bus or Ethernet connection). The reported values may be stored in onboard memory of the environmental sensor system (e.g., an SD card) as well as offboard memory (e.g., of the payload at a reduced rate). 4. Using the maximum value data as the input source, further filtering stages may be applied that can report in a first stage a 60 second maximum value and an RMS value, and in a second stage the maximum value provided every 1-60 using the values from the first stage (using the 60 second maximum value as its input) and mean RMS (using the 60 second RMS value as its input). Processed values can be sent to a remote system, such as a ground station, periodically (e.g., every 20-30 minutes, or more or less). The timing for the second stage may be configurable by the onboard processing system or by the ground station.

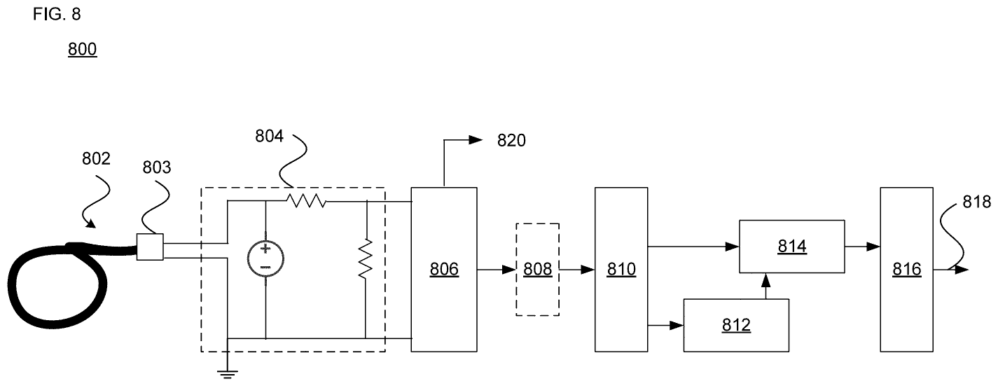

FIG. 8 illustrates one example of the magnetic field detector 516. This detector is similar to the electric field detector, except that it measures the magnetic fields generated by transient currents flowing through, e.g., a CAN bus cable of the environmental sensor system. This is done using a Rogowski coil that generates, for instance, 1 mV for every 1 A of current flowing on the CAN cable. During normal operation, there may be substantially less than 1 A. However, when there are lightning transients, there may be very short pulses of 10 A, 100 A or more of transient current. In one embodiment, the peaks of the waveform are held for a very short period of time (e.g., 1-2 microseconds), and are continuously accessible to the processor 502.

As shown, the magnetic field detector employs a Rogowski coil 802, which couples to a current sense resistor and voltage divider unit 804 via a connector 803. While it is not necessary to perform voltage division at the current sensing stage, it may help reduce the amount of division performed by the next stage at voltage divider module 806. In one scenario, the voltage divider module 806 is a /1 or /10 voltage divider. It may output a current detection range signal in addition to the divided signal. The divided signal may be filtered at block 808 before being amplified by amplifier 810. The amplified signal is provided to an inverter 812 and a peak detector 814, with the signal from the inverter also being fed to the peak detector. In one embodiment, the peak detector 814 acts as a low pass filter with a cutoff frequency on the order of, e.g., 14-18 MHz.

The output signal from the peak detector 814 is input to buffer 816. The buffer 716 also acts as a low pass filter with a cutoff frequency on the order of, e.g., 14-18 MHz. The output signal 818 is a voltage signal representing the amount of current detected, wherein the output signal may be between, e.g., 0V to 2.5V or more. A signal 820 may also be output by the voltage divider module 806, which can be used to enable or disable an opto-isolator to switch between the 1× and 10× divider ratios. Peak detection and statistics filtering for the magnetic field detector may be performed in the same manner as discussed above for the electric field detector.

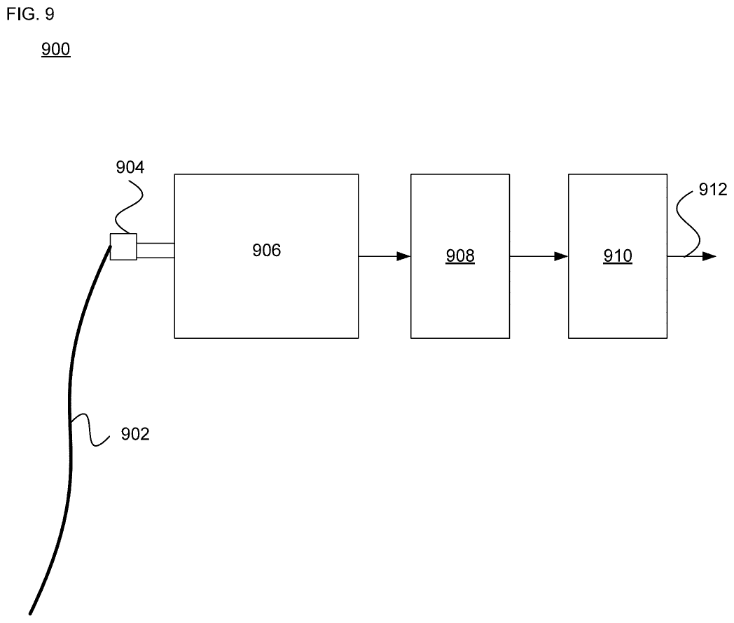

FIG. 9 illustrates one example of the corona current detector 518, which is able to detect both positive and negative electric fields. A primary risk to the HAP comes from rapidly-changing electric fields. However, it is also important to detect static electric fields, as this could be an early-warning indicator that the HAP is floating over the top of a large storm cloud. For instance, the large charge buildups in storm clouds create large static electric fields, which can adversely impact various components of the HAP. To measure the charge buildup, a “lightning rod” dangling wire 902 is designed to induce a corona discharge. The corona current detector is configured to measure the corona current (e.g., 10s or 100s of micro-amps) and use this as a proxy for the strength of the electric field. In one embodiment, the statistics from this sensor are reported over a 30-minute window by the processor 502. The wire 902 should be long enough so that it is the lowest point on the flight vehicle. In one example, it is on the order of 10-15 feet long. A threshold for the corona current detector may be adjusted, for instance by the onboard processing system or by the ground station.

As shown, the wire 902 couples to an averaging circuit 906 via a connector circuit 904. The maximum current in the wire 902 may be on the order of, e.g., 5-20 μA. The connector circuit 904 may have a resistance on the order of 100-400 kΩ, which would result in a voltage into the averaging circuit 906 on the order of, e.g., +/−2-3 volts. The system may look to see whether there is a continuous train of small corona discharges (e.g., 5-20 discharges or more or less) over a predetermined period of time. The averaging circuit 906 averages the pulses received from the wire 902 to get a DC current/voltage measurement having a cutoff frequency on the order of 3-10 Hz. The resulting signal of, e.g., +/−2.5 volts, is provided to buffer circuit 908, which may include an amplifier. The output from the buffer circuit 908 is received by a circuit 910 that acts as a voltage divider and level shifter. The circuit 910 buffers the signal, and outputs a resultant corona detection signal 912 to the processor that is a very low frequency signal (e.g., on the order of 5 Hz or less) between 0.0-2.5 volts, which can be sampled by the processor as slowly as about 1 Hz. The number of discharges in the train can be anything from a single pulse to a constant stream of pulses at dozens or hundreds of times per second.

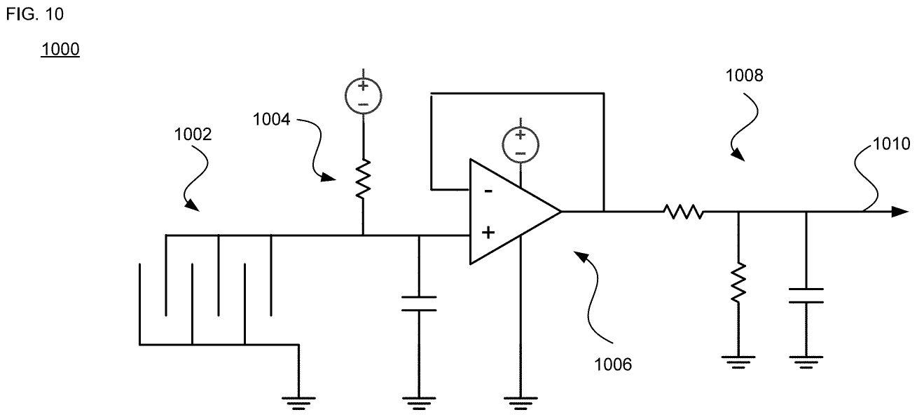

FIG. 10 illustrates one example of the moisture detector 520. Large clouds pose a moisture risk even if they do not have lightning. This is fine for the most part since the stratosphere is very dry. However, is it possible to accumulate conductive condensation or ice crystals when the HAP transits near large clouds. This can cause failures for circuits or systems that may not be waterproof.

In this example, moisture pads 1002 may be rectangular elements (e.g., 0.5″×0.5″ squares) formed of exposed, interdigitated traces, for instance with a 4 to 10 mil spacing. The moisture detector measures the resistance between these traces. If there is no moisture present, the resistance is effectively infinite (an open circuit). Should the resistance change, it would indicate the presence of moisture or ice. And if the resistance drops below ˜10 kΩ, it can indicate the likelihood of a short circuit and significant moisture.

The current flowing through a pull-up resistor 1004 is measured to determine if the resistance of these pads is decreasing. The pull-up resistor 1004 may be on the order of 5 kΩ to 20 kΩ to provide sufficient resolution. An amplifier circuit 1006 may operate as a unity-gain buffer, and circuit 1008 acts as a voltage divider (e.g., ½ divider) and low pass filter (e.g., 100-250 Hz). The resistors may be chosen so that the output voltage signal 1010 is in the range of, e.g., 0.0V to 2.5V. This output voltage is a raw voltage measurement. The processor 502 may convert it to a resistance with some post-processing. For instance, the resistance may be calculated from the output voltage, e.g., according to an equation such Vₒᵤₜ=(R/(R+10 k))*(5/2), and solving for R.

In addition to the moisture detector, humidity detection in the ambient atmosphere may also be detected by the humidity detector 532. The temperature detector 534 may be, e.g., a Resistance Temperature Detector (RTD) type sensor. The optical detector 536 may comprise one or more photodiodes or an image array configured to observe optical light flashes that occur during a lightning discharge event. By way of example, the processor may evaluate the data from the optical detector with the lightning detector, transient pulse detector and/or other detectors to determine whether there is a correlation, which would indicate actual lightning strikes.

Any or all of the detectors described herein may be arranged on one or more circuit boards of the environmental sensor system. One limiting factor in long-duration stratospheric operation is weight. In view of this, the environmental sensor system should be as lightweight as possible. Another limiting factor is power consumption. The HAP has limited power, and may only be able to generate electricity from the solar panels or other components of the power generation system during the daytime. Thus, the environmental sensor system should be configured to draw as little power as possible, especially overnight.

Yet another limiting factor is the onboard temperature. Depending where the HAP is in the stratosphere, time of day, time of year, etc., the ambient temperature may fall below −100° C., which could damage the system electronics. Therefore, as noted above, main and/or auxiliary heaters can be employed with thermal regulation strategies to maintain localized temperatures within the permissible operating range for the detectors and other HAP systems. In addition, condensation or ice buildup can be removed by using the heater elements to boost the temperature of a detector or entire circuit board by, e.g., 70° C. to 90° C. or more. This can force the full evaporation of any condensate or frost from the device.

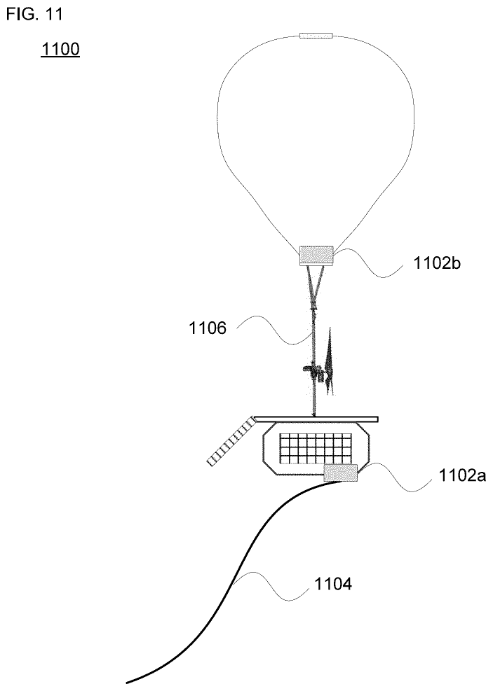

As noted above, one or more environmental sensor system suites may be arranged at various locations about the HAP. FIG. 11 illustrates one example 1100, in which a pair of sensor suites 1102 are positioned, for instance, along a bottom section or other portion of the payload (1102a) and at a lower portion of the envelope (1102b) such as adjacent to a base plate of the balloon. In the illustrated example, dangling wire 1104 may extend from suite 1102a, which may include, e.g., the corona current and magnetic field detectors.

### System Operation

The detectors of the environmental sensor system may be managed by the processor(s) to operate continuously or during certain situations. For instance, the moisture and/or humidity detectors may be operational starting at launch, which may allow the system to determine whether condensation or ice has formed as the HAP ascends to the stratosphere. In some situations, the lightning, transient pulse, electric field, magnetic field and/or corona detectors may be activated once the HAP reaches float altitude, while in other situations they may be operating at launch, for instance to troubleshoot an in-flight failure. In one example, such detectors may be activated based on weather data received from other HAPs, a ground station or a third party weather service. The data gathered can be used to address various issues associated with the impact on lightning occurring beneath a HAP operating in the stratosphere. In one scenario, the dangling wire may be pre-deployed prior to launch. In another scenario, the wire may be deployable after launch, for instance after the lighter-than-air platform clears a launch rig.

It may not be feasible to transmit raw data from the detectors to a remote ground station. Thus, in one scenario, during operation, the processor(s) are configured to perform real-time, on-board data coalescing and processing. There may be bandwidth constraints, for instance with data throughputs on the order of 10-20 measurements every 10-20 minutes. Thus, depending on the detector, the raw data may be captured (e.g., for peak detection), starting with a high sampling rate (e.g., 1 MHz) and filtered to a reduced rate (e.g., 1 Hz). Multiple stages of filtering can occur, with configurable timeframes (e.g., 20-30 minutes). Statistics (e.g., average, minimum, maximum, standard deviation, etc.) may be calculated and provided for each stage.

Once the data is collected, the information from different detectors may be compared to evaluate the likelihood of lightning or other environmental concerns. For instance, information from the optical detector may be compared against the lightning detector, transient pulse detector and/or corona current detector to see if lightning strikes are currently being observed as opposed to there being a likelihood of lightning in the near future (e.g., next 10-30 minutes).

Different methods of processing and/or correlating data may be employed, either at a remote ground station (e.g., data center or launch facility) or on the platform itself. The system may correlate the detected information with known weather activity and received weather forecasts. By way of example only, the data can be post-processed to correlate the received sensor data against historical weather data (e.g., satellite cloud-top-height imagery, convective analysis reports, and/or satellite lightning-mapping imagery). The processor(s) may employ a storm avoidance algorithm based on any or all of this information. The processed data may be used by the main control system in order to perform route planning and adjust real-time navigation of the HAP. It may also be transmitted to other HAPs in a fleet and/or to ground stations, which can use this information to update weather models, adjust routes for individual HAPs, and re-evaluate overall plans for some or all of the fleet. The system may use this information to generate alerts to inform flight engineers of nearby electrical activity so that corrective action may be taken as needed.

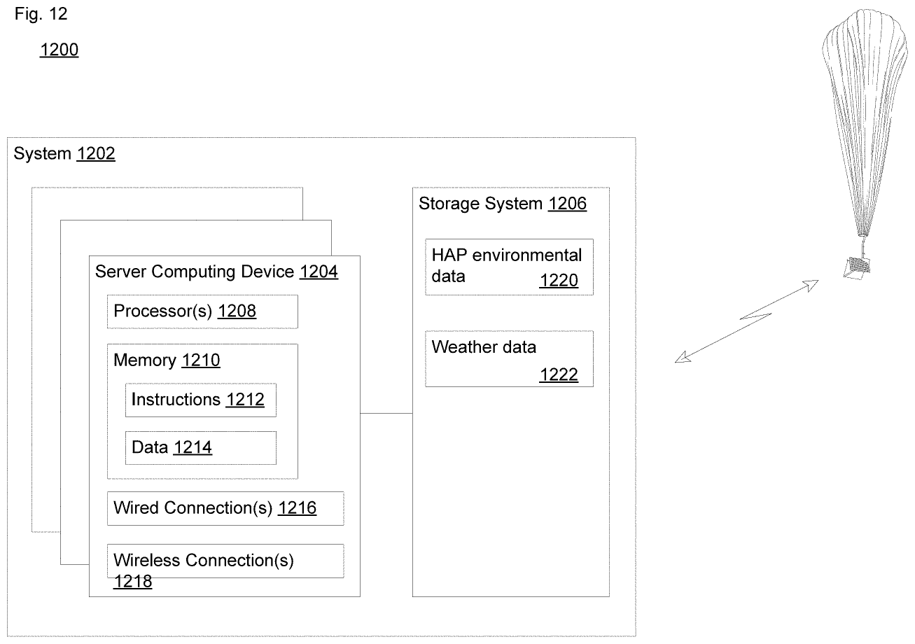

As noted above, the balloons (or other HAPs) may communicate directly or indirectly with ground-based stations. FIG. 12 illustrates one example 1200 in which a balloon (e.g., balloon 200 of FIG. 2 or balloon 400 of FIG. 4) is in communication with a station such as a server system 1202. As shown, the server system 1202 includes one or more server computing devices 1204 and a storage system 1206. In one scenario, each ground base station 106 and 112 of FIG. 1 may be a datacenter including the storage system 1206 as well as the server computing devices 1204. In this regard, the server computing devices may function as a load balanced server farm, cloud computing center or other processing hub in order to exchange information with different nodes of various networks for the purpose of receiving, processing and transmitting the data to and from other computing devices, including some or all of the high altitude platforms in a fleet of HAPs. As such, each of the one or more server computing devices 1204 may include one or more processors 1208, memory 1210 and other components typically present in general purpose computing devices.

The memory 1210 stores information accessible by the one or more processors 1208, including instructions 1212 and data 1214 that may be executed or otherwise used by the processors 1208. The memory 1210 may be of any type capable of storing information accessible by the processor, including a computing device-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 1212 may be any set of instructions to be executed directly (such as machine code) or indirectly (such as scripts) by the processors. For example, the instructions may be stored as computing device code on the computing device-readable medium. In one scenario, a storm avoidance procedure may be part of the instructions executed by the processors.

The data 1214 may be retrieved, stored or modified by processor(s) 1208 in accordance with the instructions 1212. For instance, although the technology is not limited by any particular data structure, the data may be stored in computing device registers, in a relational database as a table having a plurality of different fields and records, XML documents or flat files. The data may also be formatted in any computing device-readable format. The data may store pre- or post-processed environmental information received from the HAPs.

The one or more processors 1204 may be any hardware-based processors, such as commercially available central processing units (CPUs), graphics processing units (GPUs), and/or tensor processing units (TPUs). Alternatively, the one or more processors may be a dedicated device such as an ASIC or other hardware-based processor. Although FIG. 12 functionally illustrates the processor, memory, and other elements of system 1202 as being within the same block, it will be understood that the processor, computing device, or memory may actually include multiple processors, computing devices, or memories that may or may not be stored within the same physical housing. For example, memory may be a hard drive or other storage media located in a housing different from that of server computing devices 1204. Accordingly, references to a processor or computing device will be understood to include references to a collection of processors or computing devices or memories that may or may not operate in parallel.

The server computing devices 1204 may also include one or more wired connections 1216 and/or wireless connections 1218 to facilitate communication with other devices, such as other server computing devices and the storage system 1206, one or more information services, and other devices of the network, as well as the HAPs themselves. The information services may include, for instance, systems that provide weather predictions from organizations such as the National Oceanic and Atmospheric Administration (NOAA) or the European Centre for Medium-Range Weather Forecasts (ECMWF). The wireless network connections may include short range communication protocols such as Bluetooth™, Bluetooth™ low energy (LE), cellular connections, as well as various configurations and protocols including the Internet, World Wide Web, intranets, virtual private networks, wide area networks, local networks, private networks using communication protocols proprietary to one or more companies, Ethernet, WiFi and HTTP, and various combinations of the foregoing.

Storage system 1206 may store various types of information, including data received from one or more HAPs, such as environmental data 1220 from the HAP detector modules, and weather-related information 1222 from NOAA, ECMWF or other sources. This information may be retrieved or otherwise accessed by one or more server computing devices, such as the server computing devices 1204, in order to perform some or all of the features described herein, including data analysis, error correction, preprocessing or other operations prior to transmission to or retrieval by an entity associated with the remote facilities. As with memory 1210, storage system 1206 can be of any type of computer storage capable of storing information accessible by the server computing devices 1204, such as a hard-drive, memory card, ROM, RAM, DVD, CD-ROM, write-capable, and read-only memories. In addition, storage system 1206 may include a distributed storage system where data is stored on a plurality of different storage devices which may be physically located at the same or different geographic locations.

Storage system 1206 may be connected to the server computing devices 1204 directly (e.g., as part of server computing devices 1204 and/or via wired connections 1216) and/or via a network (e.g., via wired connections 1216 and/or wireless connections 1218). This network may include various configurations and protocols including short range communication protocols such as Bluetooth™, Bluetooth™ LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

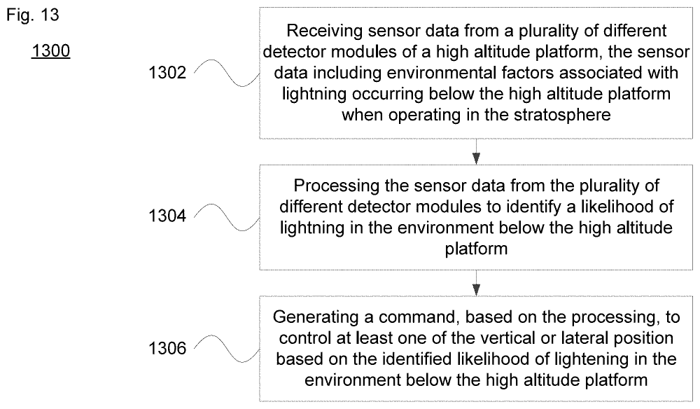

FIG. 13 illustrates a flow diagram 1300 for a method for managing high altitude platform operation in the stratosphere. As shown in block 1302, the method includes receiving sensor data from a plurality of different detector modules of a high altitude platform. The sensor data includes environmental factors associated with lightning occurring below the high altitude platform when operating in the stratosphere. At block 1304, the sensor data from the plurality of different detector modules is processed to identify a likelihood of lightning in the environment below the high altitude platform. And at block 1306, a command is generated, based on the processing, to control at least one of the vertical or lateral position based on the identified likelihood of lightening in the environment below the high altitude platform. This process may, for example, occur remotely from the high altitude platform, such as at a ground station. In one scenario, commands may be sent to multiple high altitude platforms that are part of a fleet operating in the stratosphere.

The foregoing examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. An environmental sensor system for a high altitude platform configured for operation in the stratosphere, the environmental sensor system comprising:
a plurality of different detector modules configured to detect environmental factors associated with lightning occurring below the high altitude platform when operating in the stratosphere, the plurality of different detector modules including at least a lightning detector, a transient pulse detector and an electric field detector, the plurality of different detector modules being arranged in one or more sensor suites configured for placement on the high altitude platform;
memory configured to store data received from the plurality of different detector modules, the data being associated with the detected environmental factors; and
one or more processors operatively coupled to the memory and the plurality of different detector modules, the one or more processors being configured to receive the data from the plurality of different detector modules, and to control at least one of a vertical or lateral position of the high altitude platform based on a likelihood of lightning in the environment below the high altitude platform when operating in the stratosphere.

2. The environmental sensor system of claim 1, wherein the one or more processors are further configured to:
transmit the stored data to a remote station for analysis; and
receive a command from the remote station to control at least one of the vertical or lateral position based on the likelihood of lightening in the environment below the high altitude platform.

3. The environmental sensor system of claim 1, wherein the plurality of different detector modules includes a magnetic field detector.

4. The environmental sensor system of claim 1, wherein the plurality of different detector modules includes a corona current detector.

5. The environmental sensor system of claim 4, wherein the corona current detector includes a discharge wire extending from the high altitude platform when operating in the stratosphere.

6. The environmental sensor system of claim 1, further comprising one or more additional detector modules selected from a group of a humidity detector, a temperature detector or an optical detector.

7. The environmental sensor system of claim 1, further comprising a heater module configured to heat one or more of the plurality of different detector modules above a threshold temperature.

8. The environmental sensor system of claim 7, wherein the heater module includes a main heater element and an auxiliary heater element.

9. The environmental sensor system of claim 8, wherein the auxiliary heater element is configured to increase a temperature of a moisture detector of the plurality of different detector modules.

10. The environmental sensor system of claim 1, wherein the one or more processors are further configured to transmit the stored data to another high altitude platform.

11. A high altitude platform configured for operation in the stratosphere, the high altitude platform comprising:
an envelope having a lighter-than-air gas therein;
a payload coupled to the envelope; and
the environmental sensor system of claim 1.

12. The high altitude platform of claim 11, wherein the one or more sensor suites includes first and second sensor suites, the first sensor suite being disposed along a portion of the payload, and the second sensor suite being disposed along a portion of the envelope.

13. The high altitude platform of claim 12, wherein:
the first sensor suite includes a corona current detector having a wire extending downward from the payload; and
the second sensor suite is disposed adjacent to a base portion of the envelope.

14. A method for managing high altitude platform operation in the stratosphere, the method comprising:
receiving, by one or more processors, sensor data from a plurality of different detector modules of a high altitude platform, the sensor data including environmental factors associated with lightning occurring below the high altitude platform when operating in the stratosphere;
processing, by the one or more processors, the sensor data from the plurality of different detector modules to identify a likelihood of lightning in the environment below the high altitude platform; and
the one more processors generating a command, based on the processing, to control at least one of a vertical or lateral position of the high altitude platform based on the identified likelihood of lightening in the environment below the high altitude platform.

15. The method of claim 14, further comprising transmitting the command to the high altitude platform.

16. The method of claim 14, wherein:
the plurality of different detector modules includes at least a lightning detector, a transient pulse detector and an electric field detector; and
the processing includes correlating the received sensor data from the lightning detector, the transient pulse detector and the electric field detector to determine whether the likelihood of lightening in the environment below the high altitude platform exceeds a threshold likelihood.

17. The method of claim 14, wherein the processing includes correlating the received sensor data against historical weather data.

18. The method of claim 17, wherein the historical weather data includes at least one of satellite cloud-top-height imagery, convective analysis reports, or satellite lightning-mapping imagery.

19. The method of claim 14, wherein the processing includes:
aggregating sensor data received from a fleet of high altitude platforms; and
evaluating performance of a storm-avoidance procedure employed for the fleet.

20. The method of claim 14, wherein the processing further includes performing a failure analysis to determine whether a failure is due to a storm condition.

21. The method of claim 14, wherein the processing further includes performing a failure analysis to classify a failure based on a magnitude of a detected electrical event.

22. The method of claim 14, further comprising issuing a command to vary one or more parameters of at least one of the plurality of different detector modules.
